(19) United States
(12) Patent Application Publication
(10) Pub. No.: US 2010/0039558 A1
(43) Pub. Date: Feb. 18, 2010

(54) REAL TIME HIGH DEFINITION CAPTION CORRECTION

(76) Inventor: Richard Detore, Clifton, VA (US)

Correspondence Address: DERGOSITS & NOAH LLP, Three Embarcadero Center, Suite 410, SAN FRANCISCO, CA, 94111, US

(21) Appl. No.: 12/512,392

(22) Filed: Jul. 30, 2009

Related U.S. Application Data
(60) Provisional application No. 61/188,707, filed on Aug. 12, 2008.

(51) Int. Cl. H04N 7/00

(52) U.S. Cl. 348/468; 348/E07.001

(57) ABSTRACT

Systems and methods are provided for correcting captions in real time using a closed caption decoder/encoder with a video processing system with real time program duration compression and/or expansion that adds to and/or drops frames from a captioned video signal in real time. A decoder captures caption data from the captioned input video signal, time-stamps the caption data with time codes and transmits the time-stamped caption data to a captioning processor. The captioning processor monitors the video processing system to provide a list of added and/or dropped frames. The captioning processor, with the information captured from the decoder and the video processing system, corrects the timing of the caption data and encodes the corrected captions into the edited video output signal.

### PRIORITY CLAIM

This application claims the filing priority benefit of U.S. Provisional Application No. 61/188,707, filed on Aug. 12, 2008, and titled “Real Time High Definition Caption Correction.” Provisional Application No. 61/188,707 is hereby incorporated by reference herein in its entirety.

### FIELD OF THE INVENTION

The present invention relates to video broadcasting and, in particular, to automated systems and methods for the real time correction of closed captioning included in a high definition video broadcast signal when contracting or expanding the video content of the video broadcast signal to accommodate a prescribed broadcast run time.

### BACKGROUND OF THE INVENTION

Closed captioning is an assistive technology designed to provide access to television for persons with hearing disabilities. Through captioning, the audio portion of the programming is displayed as text superimposed over the video. Closed captioning information is encoded and transmitted with the television signal. The closed captioning text is not ordinarily visible. In order to view closed captioning, viewers must use either a set-top decoder or a television receiver with integrated decoder circuitry.

The Television Decoder Circuitry Act of 1990 (“TDCA”) requires, generally, that television receivers contain circuitry to decode and display closed captioning. Specifically, the TDCA requires that “apparatus designed to receive television pictures broadcast simultaneously with sound be equipped with built-in decoder circuitry designed to display closed-captioned television transmissions when such apparatus is manufactured in the United States or imported for use in the United States, and its television picture screen is 13 inches or greater in size.”

The Federal Communication Commission's Digital TV (DTV) proceeding incorporated an industry approved transmission standard for DTV into its rules. The standard included a data stream reserved for closed captioning information. However, specific instructions for implementing closed captioning services for digital television were not included. The Electronics Industries Alliance (EIA), a trade organization representing the U.S. high technology community, has since adopted a standard, EIA-708 (High Definition Closed Captioning for purposes of this document), that provides guidelines for encoder and decoder manufacturers as well as caption providers to implement closed captioning services with DTV technology. In a Notice of Proposed Rulemaking (NPRM) in its DTV proceeding, the FTC proposed to adopt a minimum set of technical standards for closed caption decoder circuitry for digital television receivers in accordance with Section 9 of the EIA-708 standard and to require the inclusion of such decoder circuitry in DTV receivers.

It is known to those skilled in the art that the editing of a total video broadcast program, or a segment of the program, results in the loss of the synchronization of the associated high definition closed captioning as related to the original source program material. Frequently, a program, commercial or other type of video program content that is scheduled for a predetermined broadcast time slot has a total run time that does not exactly match the allocated time slot. In such cases, it is necessary to edit the program, either by contracting it by deleting frames or by expanding it by repeating frames, in order to fill the allocated time slot. This is typically done by monitoring the video segment of the broadcast signal for times of relative lack of motion, when the deletion or insertion of a frame will not be noticed by the human eye. Audio algorithms then edit the audio portion of the program signal to eliminate any discontinuity between the edited video and the audio portions of the broadcast.

Video signal processing systems are known for editing the content of an entire video program signal or program segments in order to contract or expand the total program run time to match the allocated run length or segment time. For example, such systems are available from Prime Image Delaware, Inc., Chalfont, Pa.

As stated above, while the audio and video portions of an expanded or contracted broadcast signal can be harmonized utilizing existing technology, the contraction or expansion of the total video broadcast program or segment results in the loss of the synchronization of the high definition closed captioning as related to the source program material. In editing the source program, it is expanded or contracted in a non-linear fashion. In so doing, the timing associated with the closed captioning in no longer correct. The result is a portion of the captioning being synchronized with its associated frames while, in other parts of the program, the closed captioning is out of synchronization with the video frames. Currently, an extensive amount of manual editing is required to correct each portion of the closed captioning where it is out of synchronization. The corrected closed caption material must then be re-encoded into the expanded or contracted video content to complete the process to provide a coherent broadcast signal.

In addition to the amount of time required to manually edit the program to reconstitute the closed captioning, current systems also suffer from the disadvantage that the program to be edited for synchronization of the high definition closed captioning cannot be simultaneously broadcast. Rather, it must be time delayed by the record process or delayed until the entire program material is manually processed for closed captioning correction prior to broadcast. Thus, these techniques are incompatible with the broadcasting of live events, such as sporting events and the like, where the expansion or contraction of the program material is being applied and broadcast substantially simultaneously.

Efforts to date to provide automated, real time, synchronized high definition closed captioning where an expansion or contraction of the program material is being applied and broadcast substantially simultaneously have not met with success.

### SUMMARY OF THE INVENTION

The present invention provides systems and methods for correcting high definition closed captions when using a video processing system with real time program duration contraction and/or expansion.

In accordance with an embodiment of the invention, a system for correcting closed captioning in an edited captioned video signal includes a video processing system that adds to and/or drops frames from a captioned video signal in real time to provide an edited output video signal. A decoder captures data from the original captioned video signal, time-stamps the captured caption data with time codes and transmits the time-stamped caption data to a captioning processor. The captioning processor monitors the video processing system to provide a list of frames that have been added to and/or dropped from the original video signal. The captioning processor, with the information collected from the decoder and the video processing system, also corrects the timing of the caption data and encodes the corrected captions into the edited output video signal to provide a corrected, captioned broadcast signal in real time.

The features and advantages of the various aspects of the present invention will be more fully understood and appreciated upon consideration of the following detailed description of the invention and the accompanying drawings, which set forth illustrative embodiments in which the concepts of the invention are utilized.

### BRIEF DESCRIPTION OF THE DRAWINGS

FIG. 1 is a block diagram illustrating a real time, high definition closed caption correction system in accordance with the concepts of the present invention.

FIG. 2 is a flow chart illustrating the functionality of a captioning processor in accordance with the concepts of the present invention.

FIGS. 3 and 4 illustrate the closed caption correction concepts of the present invention for contracted program material.

FIGS. 5 and 6 illustrate the closed caption correction concepts of the present invention for expanded program material.

### DETAILED DESCRIPTION OF THE INVENTION

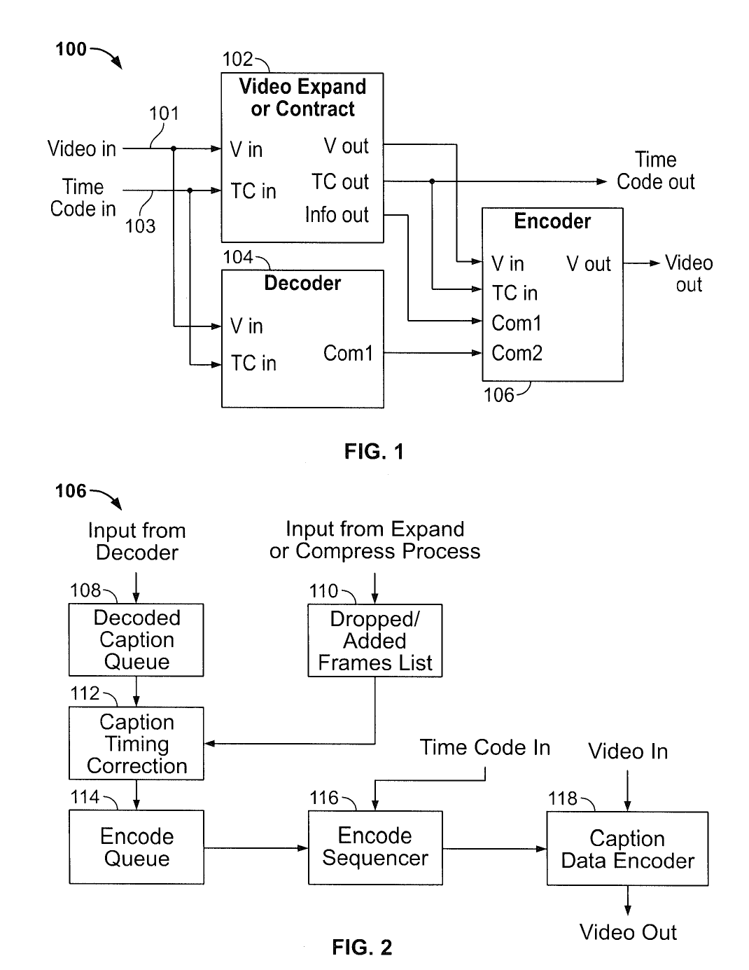

FIG. 1 shows a real time high definition caption correction system 100 in accordance with the concepts of the present invention. As shown in FIG. 1, an input video signal 101 and the associated time code data 103 included with the input video signal are provided both to a real time video program expand/contract video processing system 102 and to a decoder 104 as video in (Vin) and time code in (TCin) signals.

As is well known, a time code in this context is a sequence of numeric codes that are generated at regular intervals by a timing system. The Society of Motion Picture and Television Engineers (SMPTE) time code family is almost universally utilized in film, video and audio production and can be encoded in many different formats such as, for example, linear time code and vertical interval time code. Other related time and sequence codes include burnt-in time, CTL timecode, MIDI timecode, AES-EBU embedded timecode, rewritable consumer timecode and keykode.

As discussed in greater detail below, the video expand/contract system 102 lengthens or shortens the run time of the input video signal 101 in real time to fit an allocated broadcast time slot. The decoder 104 captures the caption data from the input video, time-stamps the caption data with time codes, and transmits the time-stamped caption data (Com1) to a captioning processor or encoder 106 in the well known manner. The video processing system 102 with real time program duration compression and expansion is monitored by the encoder 106 for a list (Info out in block 102) of the frames that have been dropped from and/or repeated in the original input video signal. The encoder 106 receives the time-stamped caption data (Com1) from the decoder 104 as well as the expanded/contracted video (Vin) signal and associated time coding (TCin) signal from the expand/contract video processing system 102, corrects the timing of the caption data, and encodes the corrected captions into the output video signal.

FIG. 2 illustrates the functional flow of the software within the encoder (captioning processor) 106 to provide a real time, synchronized corrected closed captioned video broadcast signal in accordance with the concepts of the present invention. The time-stamped caption data (Com2) received by the encoder 106 from the Com1 output of the decoder 104 is decoded, de-multiplexed and assembled into time-stamped “bursts” of caption data in a manner similar to the records in a conventional caption file. The decoder 104 transmits time codes at 270 bytes/sec (9 bytes*30 fps) and caption data at 180 bytes/sec (3 bytes*60 fps), resulting in a total of 450 bytes/sec (=4500 BAUD). Bursts of caption data can equal sub-seconds to multiple second.

These “bursts” are queued in a decoded caption queue 108. As explained in greater detail below, the list Com1 of dropped/repeated frames 110 received by the encoder 106 from the Info out output of the video processing system 102 is used to correct (112) the timing of the “bursts” stored in the decoded caption queue 108. As new dropped/repeated frame information (Com1) arrives from the video processing system 102, time stamped “bursts” of caption data are removed from the decoded data queue 108, the timing is corrected, and the “bursts” are added to an encode queue 114. An encode sequencer 116 removes the time stamped caption data “bursts” from the encode queue 114 at the proper time codes and sends the caption data to the caption data encoder module 118 in the captioning processor software.

Thus, in accordance with the process flow for real time, high definition caption correction in accordance with the concepts of the present invention, the captioning processor 106 monitors the video processing system 102 for the dropped or added frames. The captioning processor 106 generates a “start” signal when the non-linear editing process is started, indicating the total number of frames that will be dropped from (or added to) the original video broadcast signal. Then the captioning processor 106 sends a signal for each dropped (or added) frame indicating the time code value of each dropped or added frame. The video and time code being fed to the captioning processor 106 is synchronized to allow the decode prior to time reduction or increase as well as allowing enough time to process the caption data before it is time for the processor 106 to encode it into the output video signal.

The protocol for sending information from the video processing system 102 to the caption processor 106 is described below. As stated above, the captioning processor 106 requires the list of the time code values for all of the frames that are dropped from or added to the original video broadcast signal during the video time editing process. This information is transmitted as standard ASCII text strings. This allows for easy monitoring of this information using a conventional terminal program (e.g., Hyper Terminal).

Note that CR=carriage return (13, 0x0D), and LF=line feed (10, 0x0A).

### Start Command: “S 00:00:00:00 CR LF”

The ‘S’ character (83, 0x53) indicates a start command. A space character (32, 0x20) is used to delimit the start of the parameter. The time code parameter contains the total reduction time in hours, minutes, seconds, and frames.

### Drop Item: “D 00:00:00:00 00:00:00:00 CR LF”

The ‘D’ character (68, 0x44) indicates a drop item. A space character (32, 0x20) is used to delimit the start of each parameter. The first time code parameter contains the “count down” of the reduction time (i.e., the number of frames remaining to be dropped). The caption processor 106 knows that it has received the complete list of dropped frames when this parameter reaches 00:00:00:00. The second time code parameter contains the time code value of the dropped frame.

The following is a simple example of a video processing system with real time program duration compression and expansion output while shrinking a 20 frame video by 5 frames (as in the examples in the following sections of this document).

S 00:00:00:05

D 00:00:00:04 01:00:00:01

D 00:00:00:03 01:00:00:06

D 00:00:00:02 01:00:00:07

D 00:00:00:01 01:00:00:12

D 00:00:00:00 01:00:00:16

The following is the protocol for sending time-stamped caption data from the decoder 104 to the captioning processor 106; (8 data bits, no parity, 1 stop bit). The decoder 106 transmits captured caption data and time code markers in the order that this information becomes available. This allows for high definition (HD) frame rates. For example, 24 fps HD video with 24 fps time code still has the caption data encoded at 29.97 fps, so some frames contain more than two fields of caption data.

Time Code Marker: “̂C hhmmssff”

When the time code changes, the decoder 104 transmits a time code marker. A time code marker starts with ̂C (3, 0x03), and is immediately followed by eight (8) ASCII characters representing the time code value in hours, minutes, seconds, and frames. The total length of this transmission is nine (9) bytes.

Field 1 Data: “̂E bb”

The decoder 106 transmits all field 1 caption data immediately upon retrieval. It transmits ̂E (5, 0x05) followed by the two bytes of field 1 caption data (including odd parity, see EIA-608). The total length of this transmission is three (3) bytes.

Field 2 Data: “̂F bb”

The decoder 104 transmits all field 2 caption data immediately upon retrieval. It transmits ̂F (6, 0x06) followed by the two bytes of field 1 caption data (including odd parity, see EIA-608). The total length of this transmission is three (3) bytes.

### Minimum Bandwidth Requirements:

The decoder 104 transmits time codes at 270 bytes/sec (9 bytes*30 fps), and caption data at 180 bytes/sec (3 bytes*60 fields/sec), so the total will be 450 bytes/sec (=4500 BAUD).

Example Output (Hex):

| | |
|---|---|
| 03 30 31 30 30 30 30 30 30 = | 01:00:00:00 |
| 05 80 80 = | field 1 data: 80 80 (null) |
| 06 80 80 = | field 2 data: 80 80 (null) |
| 03 30 31 30 30 30 30 30 31 = | 01:00:00:01 |
| 05 94 20 = | field 1 data: 14 20 (RDC CC1) |
| 06 15 26 = | field 2 data: 15 26 (RU3 CC3) |
| 03 30 31 30 30 30 30 30 32 = | 01:00:00:02 |
| 05 94 70 = | field 1 data: 14 70 (PAC) |
| 06 94 70 = | field 2 data: 14 70 (PAC) |

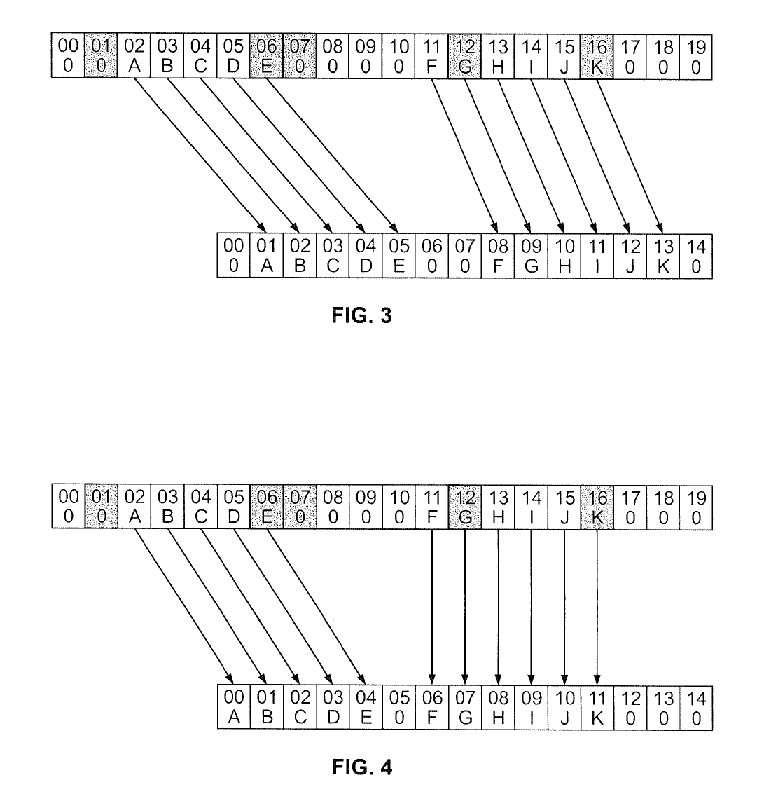

FIGS. 3 and 4 show a twenty (20) frame video being shortened to fifteen (15) frames by removing five (5) frames. Each box represents one video frame. The top line represents the twenty (20) frames of original input video; the bottom line represents the fifteen (15) frames of contracted output video. Each box contains the frame number and a letter representing the caption data for that frame (0 indicates “null” caption data). The gray boxes indicate which frames are being removed.

FIG. 3 shows how the caption data is processed when the captions are roll-up or paint-on style captions. If a caption is pop-on style, then, as discussed in greater detail below, additional processing is required to correct the caption timing properly.

For roll-up and paint-on style captions, the time code associated with a caption indicates at which frame to start encoding the caption. This is because the caption decoder 104 will start displaying the caption as soon as it receives the data. For example, in the above diagram, caption FGHIJK originally started on frame 11. Since three (3) frames were dropped by that point, the caption starts on frame 8 in the caption corrected output video.

FIG. 4 shows how the caption data is processed if the captions are pop-on style captions. For pop-on style captions, the time code associated with a caption indicates when the caption should pop on (i.e., the frame where the EOC is). This is because the caption decoder builds the caption in the background, and then the whole caption pops on at once when the decoder receives the EOC at the end. For example, in the FIG. 4 diagram, caption FGHIJK pops on at frame 16. Since five (5) frames were dropped by that point, the caption should pop on at frame 11 in the caption corrected output video; therefore, the caption will start being encoded at frame 6 so that the EOC is encoded at frame 11.

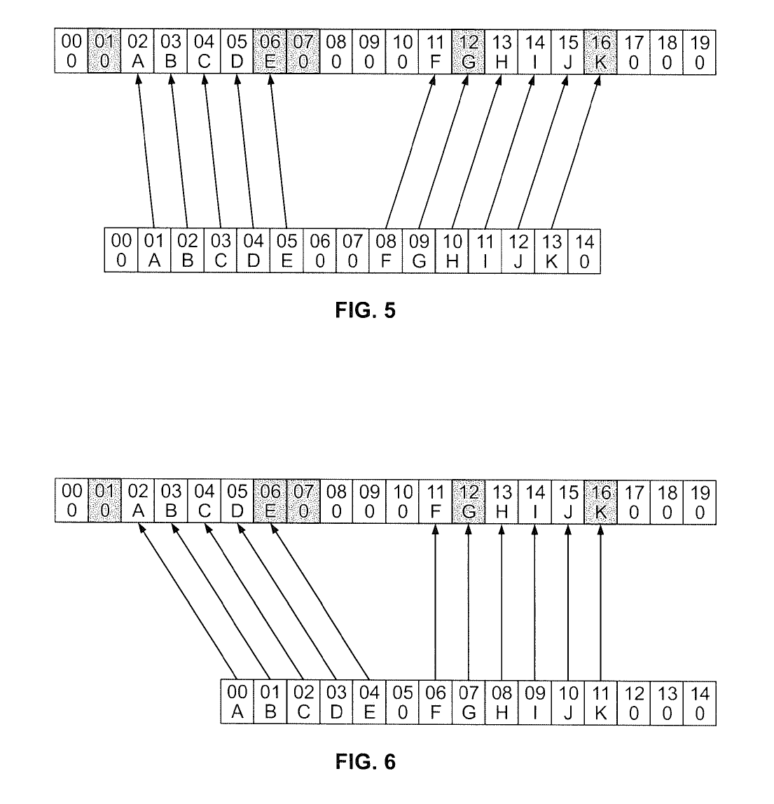

FIGS. 5 and 6 show a fifteen (15) frame video being expanded to twenty (20) frames by adding five (5) frames. Each box represents one video frame. The bottom line represents the fifteen (15) frames of original input video; the top line represents the twenty (20) frames of caption corrected expanded output video. Each box contains the frame number and a letter representing the caption data for that frame (0 indicates “null” caption data). The gray boxes indicate which frames are being dropped.

FIG. 5 shows how the caption data is processed when the captions are roll-up or paint-on style captions. If a caption is pop-on style, then, as discussed in greater detail below, additional processing is required to correct the caption timing properly.

For roll-up and paint-on style captions, the time code associated with a caption indicates what frame to start encoding the caption. This is because the caption decoder will start displaying the caption as soon as it receives the data. For example, in the FIG. 5 diagram, caption FGHIJK originally started on frame 8. Since three frames were added by that point, the caption starts on frame 11 in the caption corrected output video.

FIG. 6 shows how the caption data is processed if the captions are pop-on style captions. For pop-on style captions, the time code associated with a caption indicates when the caption should pop on (the frame where the EOC is). This is because the caption decoder builds the caption in the background, and then the whole caption pops on at once when the decoder receives the EOC at the end. For example, in FIG. 6 diagram, caption FGHIJK pops on at frame 11. Since five (5) frames were added by that point, the caption should pop on at frame 16 in the caption corrected output video; therefore, the caption should start being encoded at frame 11 so that the EOC is encoded at frame 16.

It should be understood that the particular embodiments of the invention described in this application have been provided by way of example and that other modifications may occur to those skilled in the art without departing from the scope and spirit of the invention as express in the appended claims and their equivalents.

What is claimed is:

1. A system for correcting closed captioning in an edited captioned video signal, the system comprising:
a video processing system that adds frames to and/or drops frames from an original captioned video signal in real time to provide an edited output video signal:
a decoder that captures original caption data from the original captioned video signal, time-stamps the captured original caption data with time codes and transmits the time-stamped captured original caption data to a captioning processor;
a captioning processor that monitors the video processing system to provide a list of edited frames that have been added to and/or dropped from the original captioned video signal, the captioning processor utilizing the time-stamped captured caption data provided by the decoder and the list of edited frames to correct the timing of the original caption data and to encode the time-corrected caption data into the edited output video signal.

2. The system of claim 1, wherein the caption data comprises roll-up style caption data.

3. The system of claim 1, wherein the caption data comprises paint-on style caption data.

4. A method of correcting closed captioning in an edited captioned video signal, the method comprising:
capturing original caption data from an original captioned video signal:
time-stamping the captured original caption data with time codes;
editing the original captioned video signal by adding frames to and/or dropping frames from the original captioned video signal in real time to provide an edited output video signal;
monitoring the editing step to provide a list of edited frames that have been added to and/or dropped from the original captioned video signal;
utilizing the time-stamped captured caption data and the list of edited frames to correct the timing of the original caption data and to encode the time-corrected caption data into the edited output video signal.

5. The method of claim 4, wherein the caption data comprises roll up style caption data.

6. The method of claim 4, wherein the caption data comprises paint-on style caption data.

7. The method of claim 4, wherein the editing step comprises adding frames to and/or dropping frames from the original video input signal utilizing a motion detection algorithm.

8. A method of correcting close captioning in an edited captioned broadcast signal that results from editing an original broadcast signal, the original broadcast signal including an original video signal that includes an original sequence of video frames and a corresponding sequence of original caption data that corresponds to the original sequence of video frames, the method comprising:
capturing the sequence of original caption data from the original sequence of video frames;
time-stamping the captured sequence of original caption data with a corresponding sequence of time codes;
editing the original sequence of video frames in real time by adding video frames to and/or deleting video frames from the original sequence of video frames to provide an edited output sequence of video frames;
maintaining a list of video frames that have been added to and/or deleted from the original sequence of video frames;
utilizing the time-stamped captured sequence of original caption data and the list of video frames that have been added to and/or deleted from the original sequence of video frames to correct the timing of the sequence of original caption data in real time to provide a time-corrected sequence of caption data; and
synchronizing the time-corrected sequence of caption data and the edited output sequence of video frames to provide the edited captioned broadcast signal in real time.
